(19) United States
(12) Patent Application Publication
(10) Pub. No.: US 2008/0307798 A1
(43) Pub. Date: Dec. 18, 2008

(54) Cryogenic liquid tank and method

(76) Inventors: Yang Luo, Amherst, NY (US); Reinaldo Marques, Rio de Janeiro (BR); Chien-Chung Chao, Williamsville, NY (US)

Correspondence Address: PRAXAIR, INC.;LAW DEPARTMENT - M1 557, 39 OLD RIDGEBURY ROAD, DANBURY, CT, 06810-5113, US

(21) Appl. No.: 11/811,738

(22) Filed: Jun. 12, 2007

(51) Int. Cl. F17C 13/02; F17C 3/02

(52) U.S. Cl. 62/49.1; 220/560.12

(57) ABSTRACT

A tank and method for containing a cryogenic liquid in which a purge gas is introduced into an insulation space defined between an outer vessel and an inner vessel to contain insulation material. The inner vessel is used to contain the cryogenic liquid. The purge gas can be cryogenic vapor evolved from the liquid and routed into the insulation space. Control of the purge gas within the insulation space can be provided by a programmable logic controller in which purge gas is vented from the insulation space should the pressure be indicative of a leak within the inner vessel and purge gas is introduced into the insulation space should the pressure be below the ambient to maintain a positive purge gas pressure. An adsorbent bed can also be located within the insulation space to adsorb any moisture.

### FIELD OF THE INVENTION

The present invention relates to a tank and method for containing a cryogenic liquid that is designed to allow a purge gas to be introduced into an insulation space to prevent moisture from collecting within the insulation space and degrading insulation performance.

### BACKGROUND

Cryogenic road and storage tanks are typically vacuum insulated. These tanks are formed with inner and outer vessels and an insulation space defined between the inner and outer vessels that contains insulation to prevent heat leakage from the ambient that would otherwise cause product vaporization and therefore, product loss. The commonly used insulation materials include fiberglass, PEARLITE and super insulation. The performance of these insulation systems depend on the degree to which vacuum can be maintained within the insulation space. When the vacuum level becomes compromised, the insulation materials lose their insulation performance very quickly.

Current cryogenic tank design requires a vacuum to be maintained at about 10 micrometers of mercury or less. Any mechanical damage to the tank vessel or connecting pipes will cause loss of vacuum in the insulation space. This occurrence of vacuum loss is common in cryogenic tanks that are mounted on road trailers in regions where there are poor roads. Typically, cryogenic road tankers require about one to two repairs per year and each repair can take up to several weeks or even months to perform.

There are insulation materials that can adequately function at near atmospheric pressure such as fiberglass and aerogel. However, in any tank used in storing a cryogenic liquid, whether containing a vacuum insulation, fiberglass or an aerogel, when moisture enters the insulation space, water will collect and freeze. Since the thermal conductivity of water is significantly higher than the available insulation materials, and the ice provides a pathway for heat to leak into the container to vaporize the product.

U.S. Pat. No. 4,041,722 discloses a stationary tank for storing cryogenic fluids having a metal inner vessel surrounded by a concrete outer wall that has reinforcement to resist impact loads. Insulation is provided between the inner and outer walls that is purged with a purge gas such as nitrogen and methane to prevent the ingress of moisture or water vapor into the insulation space. The use of purge gases as described in this patent could not be readily used in connection with cryogenic storage tanks that are more susceptible to damage either at the inner vessel or outer vessel due to the fact that damage to the inner vessel will cause leakage of pressurized cryogenic vapor into the insulation space to eventually damage the outer vessel. Damage to the outer vessel will of course cause loss of the purge gas in the first instance.

As will be discussed, the present invention provides a tank and method incorporating a system for maintaining a purge gas at a positive pressure within the tank and venting a purge gas in the event that there is leakage within the inner vessel and also a tank having provision for an adsorbent to adsorb any moisture that may enter the tank.

### SUMMARY OF THE INVENTION

The present invention in one aspect provides a tank for containing a cryogenic liquid. In accordance with the invention an inner vessel is provided for containing the cryogenic liquid and an outer vessel, surrounding the inner vessel, defines an insulation space there between and an insulation material is located within the insulation space to inhibit heat leakage from the ambient into the inner vessel.

A passageway allows a pressurized purge gas to pass into the insulation space and first and second remotely activated valves are positioned to control flow within the passageway and to allow the cryogenic vapor to vent from the insulation space, respectively. First and second pressure sensors are provided to sense ambient pressure of the ambient and insulation space pressure within the insulation space, respectively. A programmable logic controller is responsive to the first and second pressure sensors and is connected to the first and second remotely activated valves.

The programmable logic controller is programmed to open the first of the first and second remotely activated valves if a difference between the insulation space pressure and the ambient pressure is below a lower limit, thereby to cause the purge gas to enter the insulation space through the passageway. This maintains positive pressure within the insulation space. The second of the remotely activated valves opens if the insulation space pressure is above an upper limit, above the lower limit and indicative of leakage of the cryogenic vapor from the inner vessel to allow the purge gas to escape from the insulation space into the ambient. For example, if a breach exists in the inner vessel. In either event, a pressurized purge gas is maintained within the insulation space to prevent the ingressive moisture. At the same time since the insulation material is providing some degree of insulation at positive partial pressures, the tank will still function to maintain the cryogenic liquid between times in which the tank is inspected and any necessary repairs are made.

Preferably, a further passageway allows cryogenic vapor to escape from the inner vessel to the ambient. A third remotely activated valve is provided to control the flow within the further passageway. A third pressure sensor is provided to sense inner vessel pressure of the cryogenic vapor within the inner vessel and the programmable logic controller is also responsive to the third pressure sensor and connected to the third remotely activated valve. In such case the programmable logic controller is also programmed to open the third remotely activated valve if the inner vessel pressure is above an inner vessel limit pressure.

In any embodiment of the present invention, the passageway can communicate between an ullage space of the inner vessel in which the cryogenic vapor collects as the cryogenic vapor evolves from the liquid in the insulation space and the purge gas can consist of the cryogenic vapor.

Preferably, the lower limit is in a first range of between about 0.01 and about 0.1 psig and the upper limit is in the second range of between about 2 and about 3 psig. The inner vessel limit pressure is preferably about 30 psig where the cryogenic liquid is nitrogen, oxygen or argon and the tank is mounted on a trailer. Even more preferably, the lower limit is about 0.1 psig and the upper limit is in a range of between about 2 and about 3 psig.

Preferably, the tank as described above or in general, a tank that has an insulation space and that further uses a purge gas can be provided with an adsorbent bed located within the insulation space to adsorb moisture. Where the purge gas is nitrogen, the adsorbent bed can contain an adsorbent that preferentially adsorbs moisture at a higher temperature over the nitrogen. The adsorbent bed is located closer to the outer vessel than the inner vessel so as to operate at a temperature closer to the ambient temperature than that of the cryogenic liquid and thereby preferentially adsorb the moisture over the nitrogen.

The tank can be of cylindrical configuration and mounted on a trailer in a horizontal orientation. In such case, the adsorbent bed is located within a bottom region of said tank.

In another aspect, the present invention provides a method of storing a liquid within a tank. In accordance with this method, the cryogenic liquid is contained within an inner vessel. Heat leakage is inhibited from the ambient into the inner vessel within an insulation space defined between an outer vessel, surrounding the inner vessel. A insulation material is located within the insulation space. Ambient pressure is sensed and also insulation space pressure is sensed within the insulation space. A pressurized purged gas is introduced into the insulation space if a difference between the insulation space pressure and the ambient pressure is below a lower limit and the purged gas is vented from the insulation space if the insulation space pressure is above an upper limit, above the lower limit and indicative of leakage of the cryogenic vapor from the inner vessel.

In accordance with this aspect of the present invention, the inner vessel pressure of the cryogenic vapor is sensed within the inner vessel and the cryogenic vapor is vented from the inner vessel if the inner vessel pressure is above an inner vessel limit pressure. The purge gas can be, as stated above, a cryogenic vapor evolving from the cryogenic liquid contained within the inner vessel.

As mentioned above, the lower limit can be in a first range of between about 0.1 and about 0.1 psig and the upper limit can be in a second range of between about 2 and about 3 psig. The inner vessel limit pressure can be about 30 psig where the cryogenic liquid is nitrogen, oxygen or argon and the tank is a trailer. Preferably, the lower limit is about 0.1 psig and the upper limit is in the range of between about 2 and about 3 psig.

As also discussed above, in accordance with the method aspect of the present invention any moisture within the insulation space can be adsorbed within an adsorbent bed.

### BRIEF DESCRIPTION OF THE DRAWINGS

While the specification concludes with claims distinctly pointing out the subject matter that Applicants regard as their invention, it is believed that the invention will be better understood when taken in connection with the accompanying drawings in which:

FIG. 1 is a schematic perspective view of a tank and control system for carrying out a method in accordance with the present invention;

FIG. 2 is a logic diagram of the program logic of a programmable logic controller utilized in the tank illustrated in FIG. 1;

FIG. 3 is a schematic view of a road trailer illustrating the placement of adsorbent beds in accordance with the present invention with portions broken away to illustrate tank internals; and

FIG. 4 is a sectional view of FIG. 3.

### DETAILED DESCRIPTION

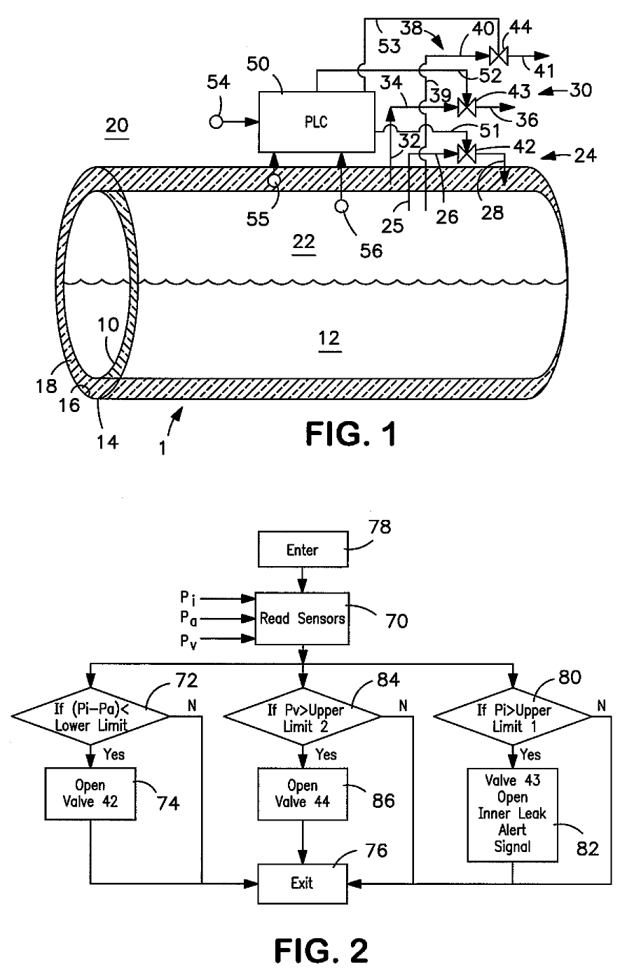

With reference to FIG. 1, a tank 1 in accordance with the present invention is illustrated. Tank 1 has a conventional inner vessel 10 for containing a cryogenic liquid 12. An outer vessel 14 surrounds the inner vessel to define an insulation space 16 between inner vessel 10 and outer vessel 12. Located within insulation space 16 is an aerogel insulation material 18 to inhibit heat leakage from ambient 20 into inner vessel 10.

Invariable heat leakage into inner vessel 10 vaporizes cryogenic liquid 12 that collects in an ullage space of inner vessel 10 as cryogenic vapor 22. In order to prevent moisture from entering insulation space 16 a passageway 24 having sections 25, 26 and 28 is provided to introduce the cryogenic vapor 22 as a purge gas into insulation space 16. It is understood, however, that as an alternative, many tank systems and virtually all road trailers are provided with pressure building circuits in which cryogenic liquid is vaporized and introduced back into the interior of vessel 10 in order to provide a motive force to drive cryogenic liquid 12 out of inner vessel 10 during filling operations. Some of the vaporized cryogenic liquid could be used as the purge gas for filling the insulation space 16. A yet further possibility, that would be particularly important in cases where liquid oxygen is to be stored and/or transported, is the use of an inert purge gas nitrogen that could be carried as a separate tank within a road trailer with a passage from such external tank to the insulation space 16.

In the illustrated embodiment, a further passageway 30 is provided having sections 32, 34 and 36 that allows vapor to vent from the insulation space 16 to the ambient 20. A yet further passageway 38 having sections 39, 40 and 41 is provided to allow the cryogenic vapor 20 to vent from the interior of inner vessel 10 should its pressure be unacceptably high. It is understood that the sections of the passageways 24, 30 and 38 are for illustration only and each of said passageways could have more or less sections.

Flows within passageway 24, passageway 30 and passageway 38 are controlled by first, second and third remotely activated valves 42, 43 and 44, respectively, that are connected to a programmable logic controller 50 by known electrical connections 51, 52 and 53. A pressure relief valve 44 controls flow within passageway 38. It is understood, however, that remotely activated valve 44 could be a mechanically operated pressure relief valve having no connection to programmable logic controller 50.

Programmable logic controller 50 is responsive to a pressure transducer 54 to sense ambient pressure, a pressure transducer 55 to sense pressure of the vapor space and preferably a pressure sensor 56 to sense pressure within the ullage space of inner vessel 10.

With reference to FIG. 2, the programming within programmable logic controller 50 is illustrated. As indicated, as a first step, “Pₐ”, “Pᵢ” and “Pᵥ” are read from pressure transducers 54, 55 and 56, respectively, as indicated in logic block 70. Pressures are then tested. As indicated in logic block 72, if a difference between Pᵢ and Pₐ is less than a lower limit, valve 42 is commanded to open as indicated in logic block 74. This is indicative that insufficient purge gas exists within insulation space 16. For example, if the difference between Pᵢ and Pₐ were less than 0 which were less than the lower limit then this would be indicative of a breach within the outer vessel 14 and the need for a purge gas to prevent moisture from entering the insulation space 16. If the test in logic block 72 yields a “no” or logically false answer, then the program is exited as indicated in logic block 76 and loops back to the initiation of the program as indicated in logic block 78.

As indicated in logic block 80, if Pᵢ is greater than an upper limit 1 which would be greater than the lower limit, then valve 43 is commanded to an open in logic block 82 and to send an alarm that could be an auditory and/or visual signal. This vents purge gas or cryogenic vapor from insulation space 16 to the ambient. Upper limit 1 is selected to be indicative that a breach or leak exists within inner vessel 10 causing the cryogenic vapor 22 to escape into the insulation space 16. Again, if the answer to the test of logic block 80 is “no” or logically false, the program proceeds to exit 76 and then loops back to block 78. If, however, the interior pressure PV within an inner vessel 10 is above an upper limit 2 then as tested in logic 84, vent valve 44 is commanded to open to relieve the pressure in logic block 86. Again, if Pᵥ is not above the upper limit 2, the program exits at 76 and recycles back to 78.

The lower limit in block 72 can, in case of a road trailer, typically be set at between about 0.01 and about 0.1 psig and preferably at about 0.1 psig. The upper limit 1 of logic block 80 can preferably be between 2 and about 3 psig. Typically, the upper limit 2 of logic block 84 is typically set at about 30 psig psig where the cryogenic liquid 12 is nitrogen, argon or oxygen and the tank 1 is a trailer. However, some trailers for nitrogen, oxygen or argon could use an upper limit pressure of about 40 psig. It is to be noted that where the cryogenic liquid 12 is carbon dioxide, the upper limit would be about 300 psig and in case of hydrogen a pressure of about 150 psig would be used. An argon railcar could be operated with an upper limit pressure of about 60 psig under a permit from the United States Department of Transportation. The on-demand purge system can be operated at three operating conditions at different pressures.

The system described above could be used in connection with new tanks having vacuum insulation. In this regard the optimal vacuum conditions will vary depending upon the insulation material used. Typically, super insulation requires a vacuum of 1 micron Hg or less, fiber glass and PEARLITE less than 50 micron of Hg. Aerogel insulation material can perform at much wider vacuum levels. Good insulation performance can be achieved with aerogel material operated at vacuum levels at 1000 micron Hg or higher.

In any such insulation system described above, it is difficult and costly to maintain hard vacuum for a long period of time. To take advantage of the low thermal conductivity at vacuum conditions, the cryogenic tanks will operate under the designed vacuum condition when the tanks are new. When cracks develop, the pressure change within insulation space 16 as sensed by pressure transducer 55 will activate the system to prevent moisture migration into the vacuum space by opening valve 25. Although not illustrated, an alarm can be sent to indicate leakage due to the cracks so that the tank can be repaired. The system described above could also be used in connection with a storage tank that was designed without vacuum insulation with the sole purpose of preventing moisture ingress into the tank.

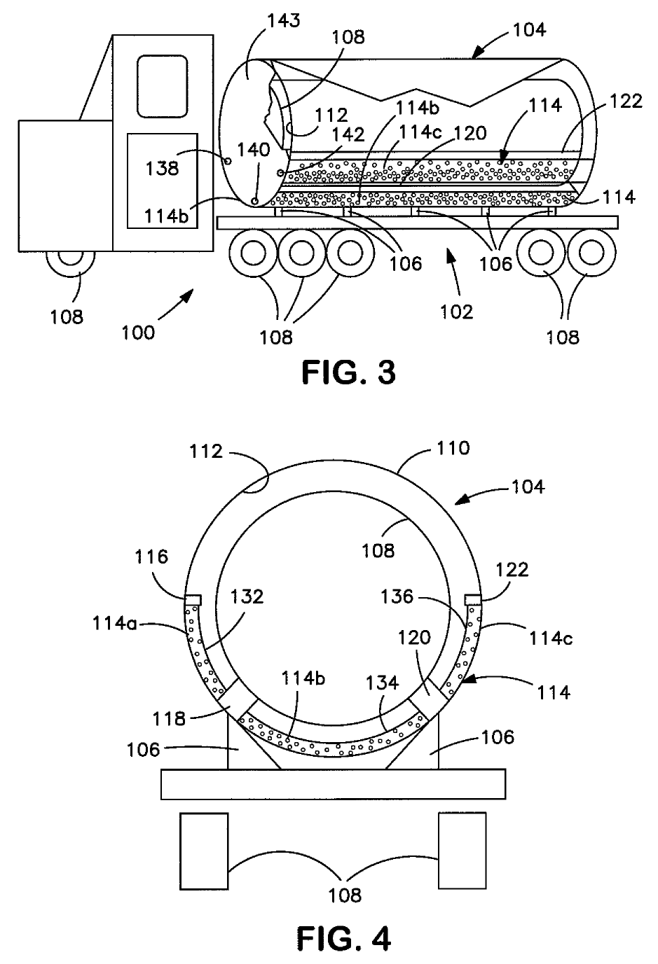

With reference to FIGS. 3 and 4, a tractor trailer 100 is illustrated having a trailer 102 that incorporates a tank 104 supported by supports 106 and having wheels 108 for transport of a liquid within tank 104. Tank 104 has an inner vessel 108 for containing a cryogenic liquid and an outer vessel 110 to define an insulation space 112 between such vessels.

In FIGS. 3 and 4, the insulation material is not illustrated but would be present within insulation space 112 and could be a vacuum insulation or preferably an aerogel. Additionally, also not illustrated, is the use of a means to introduce a purge gas such as nitrogen into insulation space 112. Such means could be those employed above with respect to tank 1. It is further understood that tank 104 could also incorporate a control system such as illustrated in FIGS. 1 and 2 and discussed above.

Tank 104 incorporates an adsorption bed 114 containing an adsorbent to adsorb any moisture that may have entered the insulation space 112. The adsorbent can be a molecular sieve such as 13X or alumina in case of a nitrogen purge gas. As illustrated, the adsorbent bed is located closer to the outer vessel 110 so that it operates at a warmer temperature than if placed closer to the inner vessel 108. The warmer operational temperature results in the adsorbent preferentially adsorbing the moisture over the nitrogen purge gas. Additionally, the adsorbent is located at the bottom of tank 104 given that this is the region of tank 104 most likely to fail upon repeated stress produced by primitive road conditions. As can best been seen in FIG. 4, preferably adsorption bed 114 consists of three sections 114a, 114b and 114c located between elongated stiffening members 116, 118, 120 and 122 and perforate mesh or plates 132, 134 and 136 to contain the adsorbent. As can best be seen in FIG. 3, also provided are fill ports 138, 140 and 142 defined in a bulkhead 143 provided in the end of tank 114 for sections 114a, 114b and 114c, respectively, by which the adsorbent can simply be vacuumed and regenerated through desorption of the moisture after removal of the same from the sections 114a, 114b and 114c for further use in trailers such as trailer 104. Although not illustrated, the adsorbent bed 114 does not have to be continuous along the tank axial direction. It could be in sections, for example, between intermediate structural formers of ring-like configuration provided between tank bulkheads provided along intermediate locations of the tank to provide structural support for inner vessel 108 and outer vessel 110. Such formers would be points in the tank at which stress would be intensified along with concomitant potential failure. Although not illustrated, heating elements can be added to the adsorbent bed or beds to regenerate the adsorbent when needed. Further, a separate air jacket located adjacent to the adsorbent beds could also be provided as an additional protection to prevent moisture migration into the insulation space.

While the present invention has been described with reference to a preferred embodiment, as will occur to those skilled in the art, numerous changes and additions and omissions may be made without departing from the spirit and the scope of the present invention as recited in the presently pending claims.

We claim:

1. A tank for containing a cryogenic liquid comprising:
an inner vessel for containing the cryogenic liquid:
an outer vessel surrounding the inner vessel to define an insulation space there between and an insulation material located within the insulation space to inhibit heat leakage from the ambient into the inner vessel;
a passageway allowing a pressurized purge gas to pass into the insulation space; and
first and second remotely activated valves positioned to control flow within the passageway and to allow the cryogenic vapor to vent from the insulation space, respectively;
first and second pressure sensors positioned to sense ambient pressure of the ambient and insulation space pressure within the insulation space, respectively; and
a programmable logic controller responsive to the first and second pressure sensors and connected to the first and second remotely activated valves;
the programmable logic controller programmed to open the first of the first and second remotely activated valves if a difference between the insulation space pressure and the ambient pressure is below a lower limit, thereby to cause the cryogenic vapor to enter the insulation space and to open the second of the remotely activated valves if the insulation space pressure is above an upper limit, above the lower limit and indicative of leakage of the cryogenic vapor from the inner vessel, thereby to cause the cryogenic vapor to escape from the insulation space to the ambient.

2. The tank of claim 1, further comprising:
a further passageway allowing cryogenic vapor to escape from the inner vessel to the ambient;
a third remotely activated valve to control the flow within the further passageway;
a third pressure sensor to sense inner vessel pressure of the cryogenic vapor within the inner vessel; and
the programmable logic controller also being responsive to the third pressure sensor, connected to the third remotely activated valve and also being programmed to open the third remotely activated valve if the inner vessel pressure is above an inner vessel limit pressure.

3. The tank of claim 1 or claim 2, wherein the passageway communicates between an ullage space of the inner vessel in which the cryogenic vapor collects as the cryogenic vapor evolves from the liquid and the insulation space.

4. The tank of claim 2, wherein:
the lower limit is in a first range of between about 0.01 and about 0.1 psig;
the upper limit is in a second range of between about 2 and about 3 psig;
the inner vessel limit pressure is about 30 psig;
the cryogenic liquid is nitrogen, oxygen or argon; and
the tank is a trailer.

5. The tank of claim 4, wherein the lower limit is about 0.1 psig and the upper limit is in a range of between about 2 and about 3 psig.

6. The tank of claim 1 or claim 2, wherein the insulation material is an aerogel.

7. The tank of claim 1 or claim 2, further comprising an adsorbent bed located within the insulation space to adsorb moisture.

8. The tank of claim 6, wherein:
the purge gas is nitrogen;
the adsorbent bed contains an adsorbent that preferentially adsorbs moisture at a higher temperature over the nitrogen; and
the adsorbent bed is located closer to the outer vessel than the inner vessel so as to operate at a temperature closer to the ambient temperature than that of the cryogenic liquid and thereby preferentially adsorb the moisture over the nitrogen.

9. The tank of claim 8, wherein:
the tank is of cylindrical configuration and mounted on a trailer in a horizontal orientation; and
the adsorbent bed is located within a bottom region of said tank.

10. A tank for containing a cryogenic liquid comprising:
an inner vessel for containing the cryogenic liquid;
an outer vessel surrounding the inner vessel to define an insulation space there between and an insulation material located within the insulation space to inhibit heat leakage from the ambient into the inner vessel;
a purge gas located in the insulation space to inhibit ingress of moisture from the ambient into said insulation space; and
an adsorbent bed located within the insulation space to adsorb any of the moisture entering the insulation space.

11. The tank of claim 10, wherein:
the purge gas is nitrogen;
the adsorbent bed contains an adsorbent that preferentially adsorbs moisture at a higher temperature over the nitrogen; and
the adsorbent bed is located closer to the outer vessel than the inner vessel so as to operate at a temperature closer to the ambient temperature than that of the cryogenic liquid and thereby preferentially adsorb the moisture over the nitrogen.

12. The tank of claim 11, wherein:
the tank is of cylindrical configuration and mounted on a trailer in a horizontal orientation; and
the adsorbent bed is located within a bottom region of said tank.

13. A method of storing a cryogenic liquid within a tank comprising:
containing the cryogenic liquid within an inner vessel;
inhibiting heat leakage from the ambient into the inner vessel with an insulation space defined between an outer vessel, surrounding the inner vessel and the inner vessel and an aerogel insulation material located within the insulation space;
sensing ambient pressure of the ambient and insulation space pressure within the insulation space; and
introducing a pressurized purge gas into the insulation space if a difference between the insulation space pressure and the ambient pressure is below a lower limit and venting the purge gas from the insulation space if the insulation space pressure is above an upper limit, above the lower limit and indicative of leakage of the cryogenic vapor from the inner vessel.

14. The method of claim 13, further comprising:
sensing inner vessel pressure of cryogenic vapor within the inner vessel; and
venting the cryogenic vapor from the inner vessel if the inner vessel pressure is above an inner vessel limit pressure.

15. The method of claim 13 or claim 14, wherein the purge gas is cryogenic vapor evolving from the cryogenic liquid.

16. The tank of claim 14, wherein:
the lower limit is in a first range of between about 0.01 and about 0.1 psig;
the upper limit is in a second range of between about 2 and about 3 psig;
the inner vessel limit pressure is about 30 psig;
the cryogenic liquid is nitrogen, oxygen or argon; and
the tank is a trailer.

17. The tank of claim 16, wherein the lower limit is about 0.1 psig and the upper limit is in a range of between about 2 and about 3 psig.

18. The tank of claim 16 or claim 17, further comprising adsorbing moisture entering the insulation space with an adsorbent bed located within the insulation space to adsorb moisture.
